(19) United States
(12) Patent Application Publication
(10) Pub. No.: US 2025/0187985 A1
(43) Pub. Date: Jun. 12, 2025

(54) PRODUCT COMPRISING LITHIATED BAYERITE AND METHOD OF MAKING SUCH A PRODUCT

(71) Applicant: SAINT-GOBAIN CENTRE DE RECHERCHES ET D'ETUDES EUROPEEN, COURBEVOIE (FR)

(72) Inventors: Patrick NGUYEN VAN NUOI, CAVAILLON CEDEX (FR); Lucas GIARDELLA, CAVAILLON CEDEX (FR)

(21) Appl. No.: 18/844,836

(22) PCT Filed: Mar. 6, 2023
(86) PCT No.: PCT/FR2023/050297

§ 371 Date: Sep. 6, 2024

(30) Foreign Application Priority Data
Mar. 7, 2022 (WO) PCT/FR2022/050403
Mar. 10, 2022 (AR) 20220100543
Mar. 10, 2022 (BO) 2022000039
Oct. 26, 2022 (FR) FR2211161

(51) Int. Cl. C04B 35/44; C04B 35/622; C04B 35/626; C04B 35/636; H01M 4/485

(52) U.S. Cl. CPC C04B 35/44; C04B 35/62222; C04B 35/62625; C04B 35/62675; C04B 35/636; H01M 4/485; C04B 2235/3218; C04B 2235/3222; C04B 2235/444; C04B 2235/6567; C04B 2235/781

(57) ABSTRACT

A product includes water, and crystallites, at least a portion, preferably substantially all of the crystallites, including lithiated bayerite, the mean size of lithiated bayerite crystallites is 10 nm or more and 25 nm or less, and the product having a combined aluminum hydroxide and boehmite content of 10% or less, the product including at least the elements Li, Cl, Al, O and H, the elements Li, Cl and Al being present in the dry product in the following contents, determined by inductively coupled plasma spectrometry, in weight percentages: −2%<Li<5%, 10%<Cl<26%, 15%<Al<30%.

### TECHNICAL FIELD

The present invention relates to a product comprising lithiated bayerite and a method of making a product comprising lithiated bayerite.

### PRIOR ART

The use of lithium, especially in batteries, is constantly increasing.

Brines are sources of lithium, for which extraction of said lithium is necessary.

This extraction, or capture, can be carried out using columns filled with an active material, which selectively and reversibly captures lithium when the brine is in contact with it.

The lithium is then recovered by passing an aqueous solution through these columns. This results in a concentrated lithium solution which will be purified before a precipitation step, generally in the form of lithium carbonate.

Lithium adsorbents, in particular lithiated bayerite, are materials advantageously used as an active material for obtaining the concentrated lithium solution within the extraction columns.

FR3053264 describes a method of preparing a crystalline solid material of formula (LiCl)ₓ·2Al(OH) 3, nH₂O with x between 0.4 and 1 and n between 0.01 and 10.

U.S. Pat. No. 4,348,295 describes a method of making of LiX·2Al(OH) 3, nH₂O, where X is an anion forming an acid in molecular combination with H or forming a salt in combination with a metal ion. Said method comprises a step of reacting a hydrated alumina with a concentrated solution of LiX at a temperature above 85° C. However, the material obtained by this method has a limited lithium adsorption capacity.

There is a need for a method of making of a product comprising lithiated bayerite, which makes it possible to obtain a product with a high lithium adsorption capacity. The aim of the invention is to satisfy this need.

### Overview of the Invention

According to the invention, this aim is achieved by means of a product comprising, and preferably consisting essentially of:
water, and
crystallites, at least a part, preferably substantially all, of said crystallites consisting of lithiated bayerite,
the mean size of lithiated bayerite crystallites is 10 nm or more and 25 nm or less, and
said product having a combined aluminum hydroxide and boehmite content of 10% or less,
said product comprising at least the elements Li, Cl, Al, O and H,
the elements Li, Cl and Al being present in said dry product in the following contents, determined by inductively coupled plasma spectrometry, in weight percentages:

$$- 2 \% < Li < 5 \% ,$$

$$- 10 \% < Cl < 26 \% ,$$

$$- 15 \% < Al < 30 \% .$$

The mean size of lithiated bayerite crystallites and the cumulative level of aluminum hydroxide and boehmite are measured on said product after exposure to air for 170 hours at 25° C. at atmospheric pressure.

Said dry product is obtained after drying under air at 200° C. for 16 hours at atmospheric pressure.

According to preferred but non-limiting embodiments of the present invention, which may, if appropriate, be combined with one another:
the product presents the following chemical analysis, determined on the dry product by inductively coupled plasma spectrometry, in percentages by weight:
Li in a content greater than 2% and less than 5%, and
Cl in a content greater than 10% and less than 26%, and
Al in a content greater than 15% and less than 30%, and
Elements other than Li, Cl, Al, O and H in a content of less than 3%, and
O and H in a content corresponding to the balance of 100%;
the average size of lithiated bayerite crystallites of less than 23 nm;
the water content is greater than 1%, preferably greater than 5%, preferably greater than 10% and/or preferably less than 95%, preferably less than 80%, preferably less than 70%;
the cumulative content of aluminum hydroxide and boehmite is less than or equal to 8%, preferably less than or equal to 5%;
the crystallized phases of the product include lithiated bayerite, boehmite and/or aluminum hydroxide selected from gibbsite, bayerite, doyleite, nordstrandite and mixtures thereof, preferably, the crystallized phases of the product comprise lithiated bayerite and an aluminum hydroxide selected from gibbsite, bayerite, doyleite, nordstrandite and mixtures thereof;
the only crystallized phase present in the product is lithiated bayerite;
at least 80% by mass of the product consists of water and crystallites of lithiated bayerite, aluminum hydroxide and/or boehmite, and LiCl, and a binder, preferably at least 80% by mass of the product, water and crystallites of lithiated bayerite, and aluminum hydroxide, and LiCl, and a binder, preferably the product consists of at least 80% by weight of water and crystallites of lithiated bayerite, and LiCl, and a binder, said binder preferably being a polysaccharide, preferably an alginate.

The invention also relates to a method of making a product according to the invention and as described above, comprising the following steps:
a) Aqueous suspension of an aluminum source, preferably a single aluminum source, selected from boehmite or aluminum hydroxide and mixtures thereof, preferably aluminum hydroxide, grinding said aqueous suspension to a median size of 3 μm or less if the median size of said aluminum source is greater than 3 μm, said suspension being maintained in step a) at a temperature below 50° C.,
b) Increasing the pH by adding a base, such that the molar ratio between the OH supplied by said base and the Al present in the mixture is greater than 0.20, said mixture being kept stirring after introduction of said base, at a temperature below 50° C.;
c) Addition of a chlorine salt, such that the molar ratio of Cl supplied by said chlorine salt to Al present in the mixture is greater than 0.25, said mixture being kept stirring after introduction of said chlorine salt at a temperature below 50° C.;
the base in step b), the chlorine salt in step c) and their respective amounts being chosen so as to provide a quantity of lithium in the mixture such that the Li/Al molar ratio is greater than or equal to 1;
d) Raising the temperature of the mixture to a temperature greater than or equal to 50° C. and less than or equal to 60° C., the time t₁ being the time during which said mixture is at a temperature greater than or equal to 50° C.;
e) Maintaining the mixture at a temperature greater than or equal to 50° C. and less than or equal to 60° C. for a time t₂;
f) Optionally, adding an acid to the mixture, with stirring, so as to reduce the pH of the mixture to 8 or less, the chlorine salt in step c), said acid and their respective quantities being chosen so that the CI/AI molar ratio in the mixture is greater than or equal to 1, the mixture being maintained at a temperature less than or equal to 60°, the time t₃ being the time during which the mixture is at a temperature greater than or equal to 50° C., the molar ratio between the CI supplied by the chlorine salt and the Al present in the mixture in step c) being greater than or equal to 0.5 if the method does not include said step f);
g) Optionally, and preferably, filtration of the mixture so as to obtain a paste, the mixture being maintained at a temperature of less than or equal to 60° C., the time t₄ being the time during which the mixture is at a temperature of greater than or equal to 50° C.;
the cumulative time t₁+t₂+t₃+t₄=t₃ being greater than or equal to 45 minutes and less than 15 hours.

According to preferred but non-limiting embodiments of the present invention, which may, if appropriate, be combined with one another:
Step a) involves grinding the aqueous suspension of an aluminum source selected from a boehmite or aluminum hydroxide and mixtures thereof, so as to obtain a median size of ≤1 μm;
the time t₃ is such that the times t₁, t₂, t₃ and t₄ satisfy the following relationships: [t₁/(−1.2T₁+75)]+ [t₂/(−1.2T₂₀+75)]+ [t₃/(−1.2T₃₀+75)]+ [t₄/(−1.2T₄₀+75)]≤1, preferably [t₁/(−0.8T₁+50)]+ [t₂/(−0.8T₂₀+50)]+ [t₃/(−0.8T₃₀+50)]+ [t₄/(−0.8T₄₀+50)]≤1, preferably [t₁/(−0.55T₁+34.5)]+ [t₂/(−0.55T₂₀+34.5)]+ [t₃/(−0.55T₃₀+34.5)]+ [t₄/(−0.55T₄₀+34.5)]≤1, and [t₁/(−0.225T₁+14.25)]+ [t₂/(−0.225T₂₀+14.25)]+ [t₃/(−0.225T₃₀+14.25)]+ [t₄/(−0.225T₄₀+14.25)]≥1, preferably [t₁/(−0.2T₁+13)]+ [t₂/(−0.2T₂₀+13)]+ [t₃/(−0.2T₃₀+13)]+ [t₄/(−0.2T₄₀+13)]≥1, where T₁ is the temperature reached by the mixture in step d), T₂₀ is the mean temperature in step e), T₃₀ is the mean temperature in step f), and T₄₀ is the mean temperature of the mixture during the time t₄;
aluminum hydroxide, boehmite and mixtures thereof are the only sources of aluminum used in all method steps, preferably aluminum hydroxide is the only source of aluminum used in all method steps;
in step b), the molar ratio between the OH provided by the base and the Al present in the mixture is greater than 0.25 and less than 10;
in step b), the pH of the mixture after addition of the base is greater than 9 and less than 13;
in step c), the molar ratio between the Cl supplied by the chlorine salt and the Al present in the mixture is less than 10;
the base in step b), the chlorine salt in step c), and their respective amounts are chosen so as to provide an amount of lithium in the mixture such that the Li/Al molar ratio is greater than 1.1 and less than 4;
in step d), the time t₁ is greater than 5 minutes;
in step e), the temperature of the mixture is substantially constant;
in step e), the time t₂ is greater than 40 minutes;
in optional step f) at least part of the amount of Cl necessary to obtain a CI/AI molar ratio greater than or equal to 1 is provided by the acid;
in optional step f) the pH of the mixture is decreased to a value below 7.5 and above 6.5;
in optional step f) the CI/AI molar ratio in the mixture is set to a value less than 3;
in optional step f) the temperature of the mixture is substantially constant;
in optional step f) the time t₃ is greater than 5 minutes;
in step g), the time t₄ is less than 15 minutes;
steps a) and b) are carried out simultaneously;
steps a), b) and c) are carried out simultaneously;
the method comprises, after step g), a step h) of shaping a starting charge comprising the paste obtained at the end of step g), in the form of an object or a coating, preferably in the form of an object, and an optional step i) reducing the water content of the object or coating;
in step h), the starting charge comprises a binder, preferably a polysaccharide comprising a group capable of forming an ionic bond with a gelling agent for the formation of a gelled polysaccharide, preferably a polysaccharide chosen from alginates;
steps h) and i) are carried out, at least partially, simultaneously.

Finally, the invention relates to a device for collecting lithium, in particular an extraction column, comprising a product according to the invention or a product obtained by the method according to the invention as described above.

### Definitions

The compound of formula LiCl·2Al(OH)₃·XH₂O, as indicated in the ICDD PDF 00-031-0700, is called “lithiated bayerite”, but also by extension, compounds with a molar ratio of lithium and aluminum, Li/Al, other than 0.5 are called by the same name. In some modes, it may be less than 0.5. According to other modes, it may be greater than 0.5.
The compound of formula Al(OH)₃ is called ‘aluminum hydroxide’. Gibbsite, bayerite, doyleite and nordstrandite are aluminum hydroxides.
The compound of formula γ-AlO(OH) is called “boehmite”.
The “cumulative aluminum hydroxide and boehmite content”, in %, in a product, is calculated according to the following formula (1):

$$T = 100 ⋆ ( {A}_{HA} + {A}_{BO} ) / ( {A}_{HA} + {A}_{BO} + {A}_{BL} ) \qquad ( 1 )$$

where
A_{HA} is the sum of the areas of the aluminum hydroxide phases, measured on an X-ray diffraction diagram of said product, for example obtained from an X'Pert diffractometer type apparatus from Panalytical, provided with a copper DX tube, without deconvolution processing, after eliminating the Kα2 line. The area of an aluminum hydroxide phase is that of its diffraction peak lying in an angular range 20 substantially equal to 18.3°;
A_{BO} is the area of the boehmite diffraction peak lying in an angular range 20 substantially equal to 14°, measured on the same diagram, without deconvolution processing, after having eliminated the Kα2 line;
A_{BL} is the area of the diffraction peak of plane (003) of lithiated bayerite lying in an angular range 20 substantially equal to 11.3°, measured on the same diagram, without deconvolution processing, after having eliminated the line Kα2.
“Polysaccharides”, according to the classical definition, are polymers composed of chains of saccharide units linked by glycosidic bonds.

The term “gelable polysaccharide” under the action of a gelling agent is a polysaccharide capable of forming a gel under the action of said gelling agent.
A gelled polysaccharide results from the association of chains of the polysaccharide under the action of a gelling agent. By way of example, alginate has the formula (C₆H₇O₆⁻)ₙ. Alginate is a polysaccharide chain comprising carboxyl groups COO⁻. Ca²⁺ calcium ions (gelling agent) react with two strands of alginate, that is to say with the carboxyl groups COO⁻, resulting in the polymerization of the alginate chains and the binding of the molecules to each other. The reaction allows the creation of a gel.
The term “dry product” means a product obtained after drying in air at 200° C. for 16 hours (at atmospheric pressure), this drying being, for example, conventionally carried out in an oven.
The “median size” of a powder of particles or of a suspension of particles is the size which divides the particles of this powder into first and second populations which are equal in weight, with these first and second populations only comprising particles having a size greater than, or less than, respectively, the median size. The median size may for example be evaluated using a laser particle size analyzer.

All the percentages in the present description are percentages by weight, unless indicated otherwise.

The verbs “contain”, “comprise” and “have” should be interpreted broadly and without limitation, unless indicated otherwise.

### DETAILED DESCRIPTION

A product according to the invention has one or more of the following optional characteristics:
Water content greater than 1%, preferably greater than 5%, preferably greater than 10% and/or preferably less than 95%, preferably less than 90%, preferably less than 80%, preferably less than 70%, or even less than 60%. The water content is the loss of mass, expressed as a percentage, after drying at 200° C. for 16 hours in air, at atmospheric pressure;
An average size of the lithiated bayerite crystallites of less than 23 nm, preferably less than 20 nm;
A cumulative aluminum hydroxide and boehmite content of 8% or less, preferably 5% or less, preferably substantially zero;
The crystallized phases comprise, preferably consist of lithiated bayerite, boehmite and/or an aluminum hydroxide chosen from gibbsite, bayerite, doyleite, nordstrandite and mixtures thereof, preferably gibbsite. Preferably, the crystallized phases comprise, preferably consist of lithiated bayerite and an aluminum hydroxide selected from gibbsite, bayerite, doyleite, nordstrandite and mixtures thereof, preferably gibbsite. Preferably, the only crystallized phase is lithiated bayerite. The determination of the crystallized phases, the determination of the cumulative content of aluminum hydroxide and boehmite and the measurement of the crystallite size of lithiated bayerite are carried out on the product after exposure to air for 170 hours at 25° C. at atmospheric pressure;
the Li, Cl and Al elements are present in said product, after drying in air at 200° C. for 16 hours, at atmospheric pressure, in the following contents, in percentages by weight:
Li: preferably greater than 2.5%, preferably greater than 3%, and/or preferably less than 4.5%, preferably less than 4%, and
Cl: preferably greater than 11%, preferably greater than 13% and/or preferably less than 24%, preferably less than 22%, and
Al: preferably greater than 17%, preferably greater than 19% and/or preferably less than 28%, preferably less than 26%;
After drying in air at 200° C. for 16 hours, at atmospheric pressure, a following chemical analysis, determined by inductively coupled plasma spectrometry, in percentages by weight:
Li in a content greater than 2%, preferably greater than 2.5%, preferably greater than 3% and less than 5%, preferably less than 4.5%, preferably less than 4%, and
Cl in a content greater than 10%, preferably greater than 11%, preferably greater than 13% and less than 26%, preferably less than 24%, preferably less than 22%, and
Al in a content greater than 15%, preferably greater than 17%, preferably greater than 19% and less than 30%, preferably less than 28%, preferably less than 26%, and
Elements other than Li, Cl, Al, O and H in a content of less than 3%, preferably less than 2%, preferably less than 1%, and
O and H in a content corresponding to the balance of 100%;
After drying in air at 200° C. for 16 hours, at atmospheric pressure, the product has a Li/Al mass ratio greater than 0.1, preferably greater than 0.15 and/or preferably less than 0.3, preferably less than 0.25;
After drying in air at 200° C. for 16 hours, at atmospheric pressure, the product has a Li/Cl mass ratio greater than 0.08, preferably greater than 0.1, preferably greater than 0.13, preferably greater than 0.15 and/or preferably less than 0.4, preferably less than 0.3, preferably less than 0.25;
The product consists, for at least 80%, preferably for more than 85%, preferably for more than 90%, preferably for more than 95%, preferably for more than 99% by weight, of water and lithiated bayerite crystallites, and aluminum and/or boehmite hydroxide, and LiCl, and a binder, preferably a polysaccharide, preferably a gelled polysaccharide, preferably an alginate, preferably a gelled alginate. Preferably, at least 80%, preferably more than 85%, preferably more than 90%, preferably more than 95%, preferably more than 99% by weight, of water and said crystallites and aluminum hydroxide and LiCl and a binder, preferably a polysaccharide, preferably a gelled polysaccharide, preferably an alginate, preferably a gelled alginate. Preferably, at least 80%, preferably more than 85%, preferably more than 90%, preferably more than 95%, preferably more than 99% by weight, of water and said crystallites and LiCl and a binder, preferably a polysaccharide, preferably an alginate;
The product is in the form of objects in the form of cylinders, polylobes, rings or spheres. Preferably, said objects have a larger dimension of less than 100 mm, preferably less than 80 mm, preferably less than 50 mm, preferably less than 30 mm, or even less than 10 mm and/or a smaller dimension, measured in a plane perpendicular to the direction of the largest dimension, greater than 1 μm or even greater than 10 μm (micrometers);
The product is in the form of a coating deposited on a support. Preferably, the thickness of said coating is greater than 10 μm, preferably greater than 50 μm, preferably greater than 100 μm, preferably greater than 200 μm, and preferably less than 1 mm, preferably less than 500 μm. Preferably, the support is made of a material chosen from ceramics, metals, organic products, in particular polymers, and mixtures thereof;
When the product contains a polysaccharide, preferably a gelled polysaccharide, preferably an alginate or a pectin, preferably a gelled alginate or a gelled pectin, preferably an alginate, preferably a gelled alginate, the amount by weight of the polysaccharide, preferably, the gelled polysaccharide is greater than or equal to 0.1%, preferably greater than or equal to 0.2%, preferably greater than or equal to 0.3% and less than or equal to 5%, preferably less than or equal to 4%, preferably less than or equal to 3%, preferably less than or equal to 2%, preferably less than or equal to 1%. The polysaccharide, alginate, contained in the binder can be demonstrated, for example, by steric exclusion chromatography.

A product according to the invention can be manufactured according to a method according to the invention comprising steps a) to g), in particular and preferably steps a) to i) mentioned above.

In step a), an aluminum source selected from a boehmite or an aluminum hydroxide and mixtures thereof, preferably an aluminum hydroxide, is placed in aqueous suspension, and if the median size of said aluminum source is greater than 3 μm, said aqueous suspension is ground so as to obtain a median size of less than or equal to 3 μm, preferably less than or equal to 2 μm, preferably less than or equal to 1 μm, preferably less than or equal to 0.7 μm, preferably less than or equal to 0.5 μm,

Said suspension being maintained during this step a) at a temperature below 50° C.

The aqueous suspension of the aluminum source and the grinding of said aqueous suspension may be carried out simultaneously.

Preferably, the grinding of the aqueous suspension is carried out if the median size of the aluminum source is greater than 2 μm, greater than 1 μm.

In a preferred embodiment, an aqueous suspension of an aluminum source selected from boehmite or aluminum hydroxide and mixtures thereof, preferably aluminum hydroxide, is ground to a median size of ≤1 μm, said suspension being maintained during this step at a temperature below 50° C.

Preferably aluminum hydroxide is gibbsite.

Preferably, aluminum hydroxide, boehmite and mixtures thereof are the only sources of aluminum used in all the steps of the method according to the invention. Preferably, aluminum hydroxide is the only source of aluminum used in all the steps of the method according to the invention.

Preferably, the median size obtained after grinding is less than or equal to 0.7 μm, preferably less than or equal to 0.5 μm.

Preferably, the suspension is maintained during step a) at a temperature greater than 15° C., preferably greater than or equal to 20° C.

The grinding may be carried out according to any technique known to the person skilled in the art, such as for example by wet grinding.

In step b), the pH of the mixture obtained at the end of step a) is increased by the addition of a base, in such a way that the molar ratio between the OH supplied by said base and the Al present in the mixture is greater than 0.20. Said mixture is kept stirring after introduction of said base, at a temperature below 50° C.

Preferably, the molar ratio between the OH provided by said base and the Al present in the mixture is greater than 0.25, preferably greater than 0.4, preferably greater than or equal to 0.5, and/or preferably less than 10, preferably less than 9, preferably less than 8, preferably less than 7, preferably less than 6, preferably less than 5, preferably less than 4, preferably less than 3, preferably less than 2, preferably less than 1.5.

Preferably, in particular when the aluminum source used in step a) is an aluminum hydroxide, the pH of the mixture after addition of the base is greater than 9, preferably greater than 10, and preferably less than 13, preferably less than 12.

Preferably, the base does not contain the aluminum element.

Also preferably, the base used is chosen from NaOH, LiOH, NH₄OH, KOH, Ca(OH)₂, RbOH, CsOH, Sr(OH)₂, Ba(OH)₂, Mg(OH)₂, and mixtures thereof. Preferably, the base is chosen from NaOH, LiOH, NH₄OH, and mixtures thereof. Preferably, the base is LiOH.

Preferably, the stirring time is greater than 5 minutes, preferably greater than 10 minutes, preferably greater than 15 minutes, and preferably less than 5 hours.

Preferably, the mixture is kept stirring at a temperature greater than 15° C., preferably greater than or equal to 20° C., preferably greater than or equal to 25° C.

In one embodiment, steps a) and b) are performed simultaneously.

In step c), a chlorine salt is added to the mixture in such a way that the molar ratio between the Cl supplied by said chlorine salt and the Al present in the mixture is greater than 0.25, said mixture being kept stirring after introduction of said chlorine salt at a temperature of less than 50° C., said molar ratio between the Cl supplied by said chlorine salt and the Al present in the mixture being greater than or equal to 0.5, preferably greater than or equal to 1, preferably greater than 1, if the method does not include step f).

In one embodiment, the method comprises step f).

Preferably, the molar ratio between the Cl supplied by said chlorine salt and the Al present in the mixture is greater than 0.25, preferably greater than 0.4, preferably greater than 0.5, and preferably less than 10, preferably less than 9, preferably less than 8, preferably less than 7, preferably less than 6, preferably less than 5, preferably less than 4, preferably less than 3, preferably less than 2, preferably less than 1.5.

Preferably the chlorine salt does not contain the aluminum element.

Also preferably, the chlorine salt is chosen from LiCl, NaCl, KCl, CaCl₂), NH₄Cl, MgCl₂ and mixtures thereof, preferably chosen from LiCl, NaCl, KCl, CaCl₂) and mixtures thereof. Preferably, the chlorine salt is LiCl.

Preferably, the stirring time is greater than 5 minutes, preferably greater than 10 minutes, preferably greater than 15 minutes, and preferably less than 48 hours.

Preferably, the mixture is kept stirring at a temperature greater than 15° C., preferably greater than or equal to 20° C., preferably greater than or equal to 25° C.

The base in step b), the chlorine salt in step c), and their respective amounts are chosen so as to provide an amount of lithium in the mixture such that the Li/Al molar ratio is greater than or equal to 1. Preferably, said molar ratio is greater than 1.1, preferably greater than 1.2, and preferably less than 4, preferably less than 2.

In one embodiment, steps a), b) and c) are performed simultaneously.

In step d), the temperature of the mixture is increased to a temperature T₁ greater than or equal to 50° C. and less than or equal to 60° C., the time t₁ being the time during which said mixture is at a temperature greater than or equal to 50° C.

Preferably, the mixture is kept stirring during step d).

Preferably, the time t₁ is greater than 5 minutes, preferably greater than 10 minutes, and preferably less than 15 hours, preferably less than 10 hours.

In step e), the mixture is maintained at a temperature greater than or equal to 50° C. and less than or equal to 60° C. for a time t₂.

Preferably, the mixture is kept stirring during step e).

Let T₂₀ be the average temperature during step e)

Preferably, during step e), the temperature of the mixture is substantially constant and equal to T₂₁.

Preferably, the time t₂ is greater than 40 minutes, preferably greater than 45 minutes, preferably greater than 60 minutes, and preferably less than 10 hours, preferably less than 7 hours.

In step f), optionally, an acid is added to the mixture with stirring so as to reduce the pH of said mixture to a value less than or equal to 8, preferably less than or equal to 7.5, and preferably greater than or equal to 6, preferably greater than or equal to 6.5, the chlorine salt in step c), said acid, and their respective amounts being chosen such that the CI/AI molar ratio in the mixture is greater than or equal to 1, preferably greater than 1, the mixture being maintained at a temperature of less than or equal to 60° C., the time t₃ being the time during which the mixture is at a temperature of greater than or equal to 50° C.

In a preferred embodiment, at least a portion of the amount of CI necessary to obtain a CI/AI molar ratio greater than or equal to 1, preferably greater than 1, is provided by said acid.

In one embodiment, several acids are added to the mixture. In this embodiment, one of the acids may comprise Cl, preferably comprises Cl.

Preferably, the acid is chosen from HCl, H₂So₄, HNO₃, HI, HBr, HClO₄, HClO₃, HMnO₄, H₂MnO₄ and mixtures thereof, preferably from HCl, HNO₃, HBr, HClO₄, HClO₃ and mixtures thereof. Preferably the acid is HCl.

Preferably, the CI/AI molar ratio in the mixture is adjusted to a value of less than 3, preferably less than 2.

Let T₃₀ be the mean temperature during step f).

Preferably, during step f), the temperature of the mixture is substantially constant and equal to T₃₁.

Preferably, the time t₃ is greater than 5 minutes, preferably greater than 10 minutes, and preferably less than 60 minutes, preferably less than 40 minutes.

The implementation of step f) depends in particular on the nature of the lithium source for which lithium extraction is envisaged, in particular its pH. By way of example, if said lithium source has a pH of less than 7, the method according to the invention preferably comprises step f).

The mixing carried out in steps b), c), d), e) and optionally f) can be carried out according to any known technique, such as, for example, with the aid of a mixer or a grinder, preferably on a wet basis with control and adjustment of the temperature of the mixture.

In step g), optional and preferred, the mixture is filtered so as to obtain a paste, said mixture being maintained at a temperature of less than or equal to 60° C., the time t₄ being the time during which the mixture is at a temperature greater than or equal to 50° C.

T₄₀ is the mean temperature of the mixture during the time t₄.

Preferably, during step g), the temperature of the mixture during time t₄ is substantially constant and equal to T₄₁.

In one embodiment, the temperature of the mixture is lowered to below 50° C. before the start of filtration.

In a preferred embodiment, the time t₄ is less than 15 minutes, preferably less than 10 minutes, preferably less than 5 minutes.

Any known filtration technique can be used during this step, in particular a filter press, a centrifuge, a band filter, a drum filter.

At the end of the optional step g), the cumulative time t₁+t₂+t₃+t₄ or t₅, the time during which the mixture has been exposed to a temperature greater than or equal to 50° C. and less than or equal to 60° C. is greater than or equal to 45 minutes and less than 15 hours.

Preferably, the time t₃ is greater than 50 minutes, preferably greater than 55 minutes, preferably greater than 1 hour.

The time t₃ is a function of the temperature and the median size of the aluminum source. The person skilled in the art knows how to adjust the time t₅ as a function of the temperature and the median size of the aluminum source. For example, if the median aluminum source size is less than 1 μm, and in step g), t₄ is 0, and the temperature in steps d), e), and f) is 50° C. (in other words T₁=T₂₁=T₃₁=50° C.), the time t₃ is greater than 3 hours and less than 15 hours, preferably less than 10 hours, preferably less than 7 hours. For example, if the median aluminum source size is less than 1 μm, and the temperature in steps d), e) and f) is 60° C. (in other words T₁=T₂₁=T₃₁=60° C.), and if the time t₄ is preferably less than 15 minutes, preferably less than 10 minutes, preferably less than 5 minutes, the time t₃ is greater than or equal to 45 minutes, preferably greater than 1 hour and less than 3 hours, preferably less than 2 hours, preferably less than 1.5 hours.

The time t₅ is preferably such that the times t₁, t₂, t₃ and t₄ satisfy the following relationships:

$$[ {t}_{1} / ( - 1.2 {T}_{1} + 75 ) ] + [ {t}_{2} / ( - 1.2 {T}_{20} + 75 ) ] + [ {t}_{3} / ( - 1.2 {T}_{30} + 75 ) ] + [ {t}_{4} / ( - 1.2 {T}_{40} + 75 ) ] \leq 1 and [ {t}_{1} / ( - 0.225 {T}_{1} + 14. 25 ) ] + [ {t}_{2} / ( - 0 \text{.22} 5 {T}_{20} + 14. 25 ) ] + [ {t}_{3} / ( - 0 \text{.22} 5 {T}_{30} + 14. 25 ) ] + [ {t}_{4} / ( 0.225 {T}_{40} + 14. 25 ) ] \geq 1.$$

Preferably, the time t₃ is such that the times t₁, t₂, t₃ and t₄ satisfy the following relationships:

$$[ {t}_{1} / ( - 0.8 {T}_{1} + 50 ) ] + [ {t}_{2} / ( - 0.8 {T}_{20} + 50 ) ] + [ {t}_{3} / ( - 0.8 {T}_{30} + 50 ) ] + [ {t}_{4} / ( - 0.8 {T}_{40} + 50 ) ] \leq 1 , preferably [ {t}_{1} / ( - 0 \text{.55} {T}_{1} + 34.5 ) ] + [ {t}_{2} / ( - 0 \text{.55} {T}_{20} + 34. 5 ) ] + {t}_{3} / ( - 0 \text{.55} {T}_{30} + 34. 5 ) ] + [ {t}_{4} / ( - 0.55 {T}_{40} + 34. 5 ) ] \leq 1 and / or [ {t}_{1} / ( - 0.2 {T}_{1} + 13 ) ] + [ {t}_{2} / ( - 0.2 {T}_{20} + 13 ) ] + [ {t}_{3} / ( - 0.2 {T}_{30} + 13 ) ] + [ {t}_{4} / ( - 0.2 {T}_{40} + 13 ) ] \geq 1.$$

In one embodiment, the temperatures in steps d), e) and optionally f) are substantially constant and equal to T₁, T₂₁ and T₃₁, respectively, and the time t₃ is such that the times t₁, t₂, t₃ and t₄ satisfy the following relationships:

$$[ {t}_{1} / ( - 1.2 {T}_{1} + 75 ) ] + [ {t}_{2} / ( - 1.2 {T}_{21} + 75 ) ] + [ {t}_{3} / ( - 1.2 {T}_{31} + 75 ) ] + [ {t}_{4} / ( - 1.2 {T}_{40} + 75 ) ] \leq 1 a nd [ {t}_{1} / ( - 0.2 \; 25 {T}_{1} + 14.25 ) ] + [ {t}_{2} / ( - 0.2 \; 25 {T}_{21} + 14.25 ) ] + [ {t}_{3} / ( - 0.2 \; 25 {T}_{31} + 14.25 ) ] + [ {t}_{4} / ( 0.225 {T}_{40} + 14. 25 ) ] \geq 1.$$

Preferably, in said embodiment, the time t₃ is such that the times t₁, t₂, t₃ and t₄ satisfy the following relationships:

$$[ {t}_{1} / ( - 0.8 {T}_{1} + 50 ) ] + [ {t}_{2} / ( - 0.8 {T}_{2} + 50 ) ] + [ {t}_{3} / ( - 0.8 {T}_{3} + 50 ) ] + \text{} [ {t}_{4} / ( - 0.8 {T}_{40} + 50 ) ] \leq 1 , \text{} preferably [ {t}_{1} / ( - 0.55 {T}_{1} + 34. 5 ) ] + \text{} [ {t}_{2} / ( - 0 \text{.55} {T}_{2} + 34. 5 ) ] + [ {t}_{3} \text{} / \text{} ( - 0 \text{.55} {T}_{3} + 34. 5 ) ] + [ {t}_{4} / ( - 0.55 {T}_{40} + 34. 5 ) ] \leq 1 and / or [ {t}_{1} / ( - 0.2 {T}_{1} + 13 ) ] + [ {t}_{2} / ( - 0.2 {T}_{21} + 13 ) ] + [ \text{} {t}_{3} \text{} / ( - 0.2 {T}_{31} + 13 ) ] + [ {t}_{4} / ( - 0.2 {T}_{40} + 13 ) ] \geq 1.$$

These relationships advantageously make it possible to improve the lithium adsorption capacity of the product according to the invention.

In one embodiment, the temperature in steps d), e) and f) is equal to 60° C. (in other words T₁=T₂₁=T₃₁=60° C.), the time t₄ preferably being less than 15 minutes, preferably less than 10 minutes, preferably less than 5 minutes, and the cumulative time t₁+t₂+t₃+t₄, in other words t₅, the time during which the mixture has been exposed to a temperature greater than or equal to 50° C. and less than or equal to 60° C. is greater than or equal to 45 minutes, preferably greater than 1 hour and less than 3 hours, preferably less than 2 hours, preferably less than 1.5 hours.

In one embodiment, the temperature in steps d), e) and f) is equal to 50° C. (in other words T₁=T₂₁=T₃₁=50° C.), the time t₄ is equal to 0, and the cumulative time t₁+t₂+t₃, in other words t₅, the time during which the mixture has been exposed to a temperature equal to 50° C. is greater than 3 hours and less than 15 hours, preferably less than 10 hours, preferably less than 7 hours.

In a preferred embodiment, the method according to the invention comprises, after step g), a step h) of shaping a starting charge comprising the paste obtained at the end of step g) in the form of an object or a coating, and an optional step i) for reducing the water content of said object.

In step h), a starting filler comprising the paste obtained at the end of step g) is shaped into the form of an object or a coating deposited on a support.

The shaping can be carried out according to any technique known to the person skilled in the art, for example extrusion, granulation, pressing, casting, atomization, screen printing, tape casting or drip gelling, especially when an object is obtained, or by stamping, lamination, coating, granulation, especially when a coating deposited on a support is obtained.

In one embodiment, the starting filler does not comprise a binder.

In one embodiment, the feedstock also includes a binder, preferably a polysaccharide comprising a moiety capable of forming an ionic bond with a gelling agent to form a gelled polysaccharide, in particular, in an amount such that the weight ratio of the amount of said polysaccharide to the total amount of said polysaccharide and of the paste obtained at the end of step g) considered dry is greater than or equal to 0.1% and less than or equal to 5%. Preferably, said mass ratio is greater than or equal to 0.2%, preferably greater than or equal to 0.3%, and preferably less than or equal to 4%, preferably less than or equal to 3%, preferably less than or equal to 2%, preferably less than or equal to 1%.

Preferably, the group of the polysaccharide capable of forming an ionic bond with a gelling agent is a carboxylate COO⁻ group.

Preferably, the polysaccharide comprises a group capable of forming an ionic bond with a gelling agent chosen from divalent cations, trivalent cations (for example a Fe or Al cation) and mixtures thereof, preferably chosen from alkaline-earth cations, preferably chosen from Ca, Sr, Ba, Mg cations and mixtures thereof. Preferably, the polysaccharide comprises a group capable of forming an ionic bond with a Ca cation.

Preferably, the polysaccharide comprising a group capable of forming an ionic bond with a gelling agent is chosen from alginates and pectins.

Preferably, the polysaccharide comprising a group capable of forming an ionic bond with a gelling agent is chosen from alginates, preferably from sodium alginates, potassium alginates, ammonium alginates, calcium alginates, and mixtures thereof, preferably among sodium alginates, potassium alginates, ammonium alginates, and mixtures thereof. Preferably the alginate is an ammonium alginate.

In the method according to the invention, the polysaccharide comprising a group capable of forming an ionic bond with a gelling agent, preferably alginate, can be provided in the form of a solution.

As is well known to the person skilled in the art, the starting filler may comprise, in addition to the paste obtained at the end of step g) and polysaccharide comprising a group capable of forming an ionic bond with a gelling agent, preferably an alginate, a solvent and/or a plasticizer and/or a lubricant, the natures and quantities of which are adapted to the shaping method of step h).

Preferably the solvent is water. The amount of solvent is adapted to the shaping method carried out in step h) as well as to the presence of polysaccharide comprising a group capable of forming an ionic bond with a gelling agent in the starting charge.

In one embodiment, in particular when the starting charge contains an amount of solvent, preferably water, which is too large compared with the shaping method envisaged in step h), a step of removing part of the solvent may be carried out, before step h).

In one embodiment, step f) makes it possible to obtain a paste having a solvent content, preferably water content, adapted to the shaping method envisaged in step h).

The starting filler optionally contains a plasticizer.

Preferably, the plasticizer content is between 0.1% and 10%, preferably between 0.5% and 5%, preferably between 0.5% and 2%, by weight based on the weight of the paste obtained at the end of step g) of the starting charge.

All the plasticizers conventionally used for the manufacture of porous ceramic products can be used, for example polyethylene glycol, polyolefin oxides, hydrogenated oils, alcohols, in particular glycerol and glycol, esters, and mixtures thereof.

In a preferred embodiment, the starting filler does not contain plasticizers.

The starting charge optionally contains a lubricant. Preferably, the lubricant content is between 0.1% and 10%, preferably between 0.5% and 5%, preferably between 0.5% and 2%, by weight based on the weight of the paste obtained at the end of step g) of the starting charge.

All the lubricants conventionally used for the manufacture of porous ceramic products can be used, for example petroleum jelly and/or glycerin and/or waxes.

The presence and nature of the lubricant and/or plasticizer depend in particular on the shaping technique used in step h).

In a preferred embodiment, the feedstock does not contain lubricants.

In a preferred embodiment, the feedstock does not contain any other constituents than the paste obtained at the end of step g), the binder, preferably a polysaccharide, and a solvent.

The mixing of the various constituents of the starting feed can be carried out according to any technique known to the person skilled in the art, for example in a mixer, preferably in a high intensity mixer or in a Z-arm mixer, in turbulate, in a jar mill with balls, preferably alumina beads. The mixing is preferably carried out in a high intensity mixer or in a Z-arm mixer

The total mixing time is preferably greater than 5 minutes, and preferably less than 30 minutes, preferably less than 20 minutes.

Step h) may be preceded by a step of removing at least part of the solvent, so as to adapt the amount of solvent, preferably water, to the shaping technique envisaged in step h). All known techniques for removing at least in part a solvent, preferably water, can be used, preferably drying, preferably in air, at atmospheric pressure. Preferably, the maximum temperature reached during said drying is greater than 20° C., and preferably less than 100° C.

The objects obtained after shaping can be in the form of cylinders, polylobes, rings, or spheres. Preferably, said objects have a larger dimension of less than 100 mm, preferably less than 80 mm, preferably less than 50 mm, preferably less than 30 mm, or even less than 10 mm and preferably more than 1 mm and/or a smaller dimension, measured in a plane perpendicular to the direction of the largest dimension, greater than 1 μm or even greater than 10 μm (micrometers).

The coating obtained after shaping may have a thickness greater than 10 μm, preferably greater than 50 μm, preferably greater than 100 μm, preferably greater than 200 μm, and preferably less than 1 mm, preferably less than 500 μm. Preferably, the support is made of a material chosen from ceramics, metals, organic products, in particular polymers, and mixtures thereof.

A preferred embodiment will now be described.
In said preferred embodiment, in step h), the starting filler contains a polysaccharide, preferably an alginate, and is shaped so as to obtain a preform, said shaping being carried out according to any technique known to the person skilled in the art, for example extrusion, granulation, pressing, casting, atomization, screen printing, tape casting or drip gelling. Preferably, in said embodiment, the shaping is carried out by screen printing.
Then, still according to this preferred embodiment, the preform is brought into contact with a solution comprising a gelling agent capable of gelling the polysaccharide, preferably alginate.

The solution comprising a gelling agent capable of gelling the polysaccharide, preferably alginate, is well known to the person skilled in the art.

The gelling agent is preferably chosen from divalent cations, trivalent cations and mixtures thereof, preferably chosen from alkaline-earth cations, preferably chosen from Ca, Sr, Ba, Mg cations and mixtures thereof. Preferably, the gelling agent is a Ca cation.

The solution containing the gelling agent is preferably selected from a solution comprising a divalent cation salt, a solution comprising a trivalent cation salt, or the lithium source from which lithium is extracted, preferably brine, in particular when it contains such a cation.

Preferably, the solution comprising a divalent cation salt or a trivalent cation salt is selected from an iodide solution of said cation and/or a chloride solution of said cation.

Preferably, the gelling solution is a solution comprising an alkaline-earth cation iodide and/or an alkaline-earth cation chloride. Also preferably, the gelling solution is a solution comprising an alkaline-earth cation chloride, preferably a solution comprising calcium chloride.

In a preferred embodiment, the gelling solution is the source of lithium from which the lithium is extracted, preferably brine from which the lithium is to be collected, especially when the latter comprises a divalent and/or trivalent cation.

In another possible embodiment, the gelling solution is a calcium chloride solution, the calcium chloride concentration of which is preferably greater than 1 mol/l, preferably greater than 2 mol/l of solution.
The preform can be brought into contact with the gelling solution, for example, by immersing the preform in a bath of gelling solution or by spraying the preform with the gelling solution.

In one embodiment, the shaping and bringing the preform into contact with the gelling solution are coincident, in particular when the preform is implemented by drop-by-drop gelling.

In step i), optional and preferred, the water content of the object or of the coating obtained at the end of step h) is reduced.

This reduction in water content can be carried out by drying.

Preferably, the maximum temperature reached during said drying is greater than 20° C., and preferably less than 100° C., preferably less than 80° C., preferably less than 60° C.

Also preferably, the drying cycle has a plateau at said maximum temperature reached. The holding time at the plateau is preferably greater than 5 seconds and preferably less than 20 hours. Drying is preferably carried out in air at atmospheric pressure.

Preferably, the water content of the product at the end of step i) is greater than 1%, preferably greater than 5%, preferably greater than 10% and preferably less than 60%, based on the mass of the product.

In one embodiment, steps h) and i) can be carried out, at least partially, simultaneously.

The invention also relates to a product according to the invention obtained by the method according to the invention.

### Examples

The following non-limiting examples are given with the aim of illustrating the invention.

The nature of the crystallized phases of the objects of the examples is determined by the following conventional method:

The products of the examples are previously exposed to air for 170 hours at 25° C., at atmospheric pressure.

The acquisitions are carried out by means of an X'Pert type apparatus from Panalytical, equipped with a copper anode, over an angular range 20 of between 5° and 80°, with a step of 0.017°, and a counting time of 300 s/step. The front lens has a fixed divergence slit of 0.25°, a Soller slit of 0.02 rad, a mask of 10 mm and a fixed anti-scatter slit of 0.5°. The sample is rotating on itself. The rear optics feature a fixed 0.25° anti-scatter slit, a 0.02 rad Soller slit and a nickel filter.

The diffraction diagrams are then analyzed qualitatively using the EVA software and the ICDD2016 database.

The ICDD2016 PDF data sheet 00-031-0700 identifies the phase (LiCl)·2Al(OH)₃, xH₂O.

The crystallized phase of lithiated bayerite demonstrated may exhibit a slight angular shift of the peaks with respect to said data sheet, a consequence in particular of the quantity of Li inserted into the structure of the lithiated bayerite.

The mean size of the lithiated bayerite crystallites D of the products of the examples is conventionally determined by X-ray diffraction on a powder of said product, previously exposed to air for 170 hours at 25° C., at atmospheric pressure, using an X'Pert type device from Panalytical, using the following Debye-Scherrer equation:

$$D = \frac{K λ}{\sqrt{( {B}^{2} - {b}^{2} )} cos θ} \times \frac{1}{10} \times \frac{180}{π}$$

K being equal to 0.89,
λ being the wavelength of X-rays, here equal to that of copper, or 1.54 angstrom,
B being the half-height width of the peak of plane (003) of lithiated bayerite (ICCD database PDF data sheet 00-031-0700), in degrees,
b being the width at mid-height of the peak of the monocrystalline silicon standard used, here measured equal to 0.05°, and
2θ being the angle of the peak intensity maximum corresponding to plane (003) of lithiated bayerite, in degrees.

The diffraction diagrams of the monocrystalline silicon standard and of the example are acquired over an angular range 20 of between 5° and 80°, with a step of 0.017°, and a counting time of 300 s/step for the example and 100 s/step for the monocrystalline silicon standard. The front lens has a fixed divergence slit of 0.25°, a Soller slit of 0.02 rad, a mask of 10 mm and a fixed anti-scatter slit of 0.5°. The sample is rotating on itself. The rear optics feature a fixed 0.25° anti-scatter slit, a 0.02 rad Soller slit and a nickel filter.

After removing the Kα2 line, the mid-height width of the peaks is determined using the EVA software, and the mean size of the lithiated bayerite crystallites is determined using the FWHM function.

The determination of the cumulative aluminum hydroxide and boehmite content was carried out on the basis of the same X-ray diffraction patterns used for the detection of the crystallized phases present. After removing the Kα2 line and using the EVA software, it is possible to measure the area A_{HA} of the aluminum hydroxide diffraction peak present in an angular range 20 substantially equal to 18.3°, the area A_{BO} of the boehmite diffraction peak in an angular range 20 substantially equal to 14°, and the area A_{BL} of the lithiated bayerite diffraction peak in an angular range 20 substantially equal to 11.3°. The cumulative aluminum hydroxide and boehmite content is then calculated according to the formula (1) given above:

$$T = 100 ⋆ ( {A}_{HA} + {A}_{BO} ) / ( {A}_{HA} + {A}_{BO} + {A}_{BL} ) \qquad ( 1 )$$

Thus, where the product does not contain aluminum hydroxide or boehmite, the cumulative aluminum hydroxide and boehmite content is 0.

With the exception of the elements O and H, the contents of the various elements present in the products of the examples are determined, on products dried in air at 200° C. for 16 hours, at atmospheric pressure, by inductively coupled plasma spectrometry (or “ICP”).

The water content is determined as the loss of mass, expressed as a percentage, after drying in air at 200° C. for 16 hours at atmospheric pressure. After such drying, the product is said to be “dry”.

The content of the elements other than H and O, partly Li, Cl and Al, is determined on the dry product by inductively coupled plasma spectrometry, using an Agilent 5800 ICP-OES apparatus.

The median size of a powder or suspension is measured using a laser granulometer of model LA950V2 marketed by Horiba.

### Manufacturing Protocol

The following raw materials were used for the examples.
A gibbsite Al(OH)₃ powder, having a median size equal to 1.6 μm, of purity greater than 99.5% by mass and a specific surface area equal to 5 m²/g, for examples 1 to 5,
Lithium hydroxide monohydrate (LiOH, H₂O), of purity greater than 99.5% by mass, for examples 2 to 5,
Lithium chloride LiCl, of purity greater than 99.5% by mass, for examples 1 to 5,
Hydrochloric acid HCl, of purity greater than 99% by mass, in 16M aqueous solution, for examples 2 to 5,
An ammonium alginate of purity greater than 99% by mass, for examples 2 to 5.

The product of example 1, outside the invention and in accordance with the teaching of U.S. Pat. No. 4,348,295, is the product of example 1 of U.S. Pat. No. 4,348,295 and was obtained in the following manner:
50 g of gibbsite are added to 200 ml of a 20% by weight LiCl solution, and the mixture obtained is then stirred for 2 hours at 115° C.

The mixture obtained is filtered over Büchner, at ambient temperature (less than 50° C.), with filter papers having a permeability equal to 2 μm so as to obtain a pulp.

The products of examples 2 to 5 were obtained in the following manner:

In step a), for each example, 500 g of aluminum hydroxide are added to 2,000 g of water, at a temperature equal to 25° C., in a LabStar mill marketed by NETZSCH and ground for 75 minutes. At the end of step a), the aluminum hydroxide suspended in water has a median size of 0.55 μm.

In step b), for each example, (LiOH, H₂O) is added to the mixture obtained at the end of step a), so that the molar ratio between the OH supplied by (LiOH, H₂O) and the Al initially present in the mixture is as described in Table 1. For each example, the temperature at which this step took place, the mixing time and the pH of the mixture measured at the end of this step are also described in Table 1.

In step c), for each example, LiCl is added to the mixture obtained at the end of step b), so that the molar ratio between the Cl supplied by LiCl and the Al initially present in the mixture is as described in Table 1. For each example, the temperature at which this step took place and the mixing time are described in Table 1.

At the end of step c), the amount of lithium in the mixture, expressed as the Li/Al molar ratio, is as described in Table 1.

In step d), the mixture is heated by means of a heating plate, to a temperature T₁, the time t₁ being the time during which said mixture is at a temperature greater than or equal to 50° C. Table 1 describes for each example the temperature T₁ and the time t₁.

In step e), for each example, the mixture is maintained at a constant temperature T₂₁ for a time t₂. Table 1 describes for each example the temperature T₂₁ and the time t₂.

In step f), for each example, HCl is added to the mixture obtained at the end of step e), so that the pH of the mixture is lowered to the value indicated in Table 1, the CI/AI molar ratio value in the mixture after the addition of HCl is as described in Table 1, the acid being introduced at a temperature equal to T₃₁ kept constant during step f), the time t₃ being the time during which the mixture is at a temperature greater than or equal to 50° C. T₃₁ and t₃ are described in Table 1.

In step g), for each example, the mixture is filtered through Büchner, at ambient temperature (less than 50° C.), with filter papers having a permeability of 2 μm so as to obtain a paste. The time t₄ during which the mixture is at a temperature greater than or equal to 50° C. is described in Table 1.

The time to, equal to the sum of the times t₁+t₂+t₃+t₄, is also described, for each example, in Table 1.

Table 1 below summarizes the parameters used in the manufacturing steps of examples 2 to 5.

TABLE 1

| | Example | | Example | | Example | | Example | |
|---|---|---|---|---|---|---|---|---|
| | 2 | | 3 | | 4 (*) | | 5 | |
| Step b), amount of LiOH, H₂O | 134.15 | | 134.15 | | 134.15 | | 134.15 | |
| added, in g | | | | | | | | |
| Step b), OH/Al molar ratio | 0.5 | | 0.5 | | 0.5 | | 0.5 | |
| Temperature at which step b) | 25° | C. | 25° | C. | 25° | C. | 25° | C. |
| took place | | | | | | | | |
| Step b), mixing time | 15 | min | 5 | min | 15 | min | 15 | min |
| Step c), Cl/Al molar ratio | 1 | | 1 | | 1 | | 1 | |
| Temperature at which step c) | 25° | C. | 25° | C. | 25° | C. | 25° | C. |
| took place | | | | | | | | |
| Step c), mixing time | 15 | min | 37 | min | 15 | min | 15 | min |
| Li/Al molar ratio in the mixture | 1.5 | | 1.5 | | 1.5 | | 1.5 | |
| at the end of step c) | | | | | | | | |
| Step d), temperature T₁ | 50° | C. | 60° | C. | 60° | C. | 60° | C. |
| Step d), time t₁ | 0 | min | 15 | min | 15 | min | 15 | min |
| Step e), temperature T₂₁ | 50° | C. | 60° | C. | 60° | C. | 60° | C. |
| Step e), time t₂ | 4 h 45 | | 45 | min | 10 | min | 20 | min |
| Step f), pH after addition of | 3 | | 3 | | 3 | | 3 | |
| HCl | | | | | | | | |
| Step f), Cl/Al molar ratio after | 1.6 | | 1.6 | | 1.6 | | 1.6 | |
| addition of HCl | | | | | | | | |
| Step f), temperature T₃₁ | 50° | C. | 60° | C. | 60° | C. | 60° | C. |
| Step f), time t₃ | 15 | min | 15 | min | 5 | min | 5 | min |

| | | | | | | | |
|---|---|---|---|---|---|---|---|
| Step g), time t₄ | 0 | 5 | min | 5 | min | 5 | min |

| | | | | | | | |
|---|---|---|---|---|---|---|---|
| Time t₅ = t₁ + t₂ + t₃ + t₄ | 5 | h | 1 h 20 | 35 | min | 45 | min |

(*) outside the invention

The various pastes obtained have the characteristics shown in Table 2 below.

TABLE 2

| | Example | Example | Example | Example | Example |
|---|---|---|---|---|---|
| | 1 (*) | 2 | 3 | 4 (*) | 5 |
| Quantity of water, in | 60% | 60% | 65% | 65% | 70% |
| percentage by mass | | | | | |
| Average crystallite | 55 | 15.4 | 16.8 | 18.2 | 17.3 |
| size of lithiated | | | | | |
| bayerite (nm) | | | | | |
| Crystallized phases | Lithiated | Lithiated | Lithiated | Lithiated | Lithiated |
| demonstrated | bayerite | bayerite | bayerite | bayerite, | bayerite, |
| | | | | gibbsite | gibbsite |
| Cumulative | Not | 0 | 0 | 30 | 10 |
| aluminum hydroxide | determined | | | | |
| and boehmite | | | | | |
| content (%) | | | | | |

Chemical analysis by inductively coupled plasma spectrometry,
after drying in air at 200° C. for 16 hours, at atmospheric
pressure, in percentage by weight

| | | | | | |
|---|---|---|---|---|---|
| Li content (%) | 4.31 | 4.21 | 3.83 | 3.13 | 4.23 |
| Cl content (%) | 22.02 | 21.51 | 19.56 | 15.99 | 21.61 |
| Al content (%) | 21.1 | 19.1 | 21.9 | 20.5 | 20.3 |
| Content in elements | 0.1 | 0.1 | 0.1 | 0.1 | 0.1 |
| other than Li, Al, | | | | | |
| Cl, O and H (%) | | | | | |
| O and H elements (%) | Supplement | Supplement | Supplement | Supplement | Supplement |
| | to 100 | to 100 | to 100 | to 100 | to 100 |

(*) outside the invention

The products of the examples 2 and 3 consist of more than 99% by mass of water, lithiated bayerite and LiCl.

The products of the examples 4 and 5 consist of more than 99% by mass of water, lithiated bayerite, gibbsite and LiCl.

For each example, the paste obtained was then shaped in the following manner.

For example 1, the paste obtained after filtration was spread on a metal grid with a thickness of 1 mm and perforated with circular holes with a diameter of 1.5 mm, then scraped with a spatula on each side of the grid so that said paste fills the holes of said grid. The grid is then called “charged”. Once the grid is charged, it is placed under a circulation of hot air at 60° C., which makes it possible to “discharge” said grid, the objects formed falling into a container placed under the grid. The objects obtained are in the form of cylinders of average length equal to 0.8 mm and of average diameter equal to 1.4 mm.

For examples 2 to 5, in step h), a starting charge consisting of the paste obtained at the end of step g) and ammonium alginate was produced, the content of said alginate being equal to 1% by weight based on the weight of the starting charge after drying at 200° C. for 16 hours at atmospheric pressure.

Said paste and the ammonium alginate were mixed in a planetary mixer under hot air created by a thermal stripper set to a temperature equal to 100° C., for 120 minutes so as to obtain a homogeneous starting charge and having a water content compatible with the shaping technique.

The starting load was then spread on a metal grid with a thickness of 1 mm and perforated with circular holes with a diameter of 1.5 mm, then scraped with a spatula on each side of the grid so that said starting charge fills the holes of said grid. The grid is then called “charged”. Once the grid is charged, it is placed under a circulation of hot air at 60° C., which makes it possible to “discharge” said grid, the objects formed falling into a container placed under the grid. The objects obtained are in the form of cylinders of average length equal to 0.8 mm and of average diameter equal to 1.4 mm.

Examples 2 and 3, according to the invention, have a high lithium adsorption capacity.

The shaped objects of examples 2 and 3, according to the invention, have a capacity for adsorption of lithium greater than that of example 1, according to the prior art. This comparison also highlights the importance of limiting the temperature to 60° C. in the method of making of the product.

A comparison of example 4, excluding the invention, and of example 3, according to the invention, shows that in example 4, a time t₅, during which time the mixture is at a temperature greater than or equal to 50° C., equal to 35 minutes for a temperature in step e) at 60° C. leads to a product with a cumulative aluminum hydroxide and boehmite content of 30%, which limits its capacity to adsorb lithium.

Of course, the invention is not limited to the embodiments described, which are provided merely for illustrative purposes.

1. A product comprising:
water, and
crystallites, at least part of said crystallites consisting of lithiated bayerite,
a mean size of lithiated bayerite crystallites is 10 nm or more and 25 nm or less, and
said product having a combined aluminum hydroxide and boehmite content of 10% or less,
said product comprising at least the elements Li, Cl, Al, O and H,
the elements Li, Cl and Al being present in said dry product in the following contents, determined by inductively coupled plasma spectrometry and in weight percentages:
$$2 \% < Li < 5 \% ,$$
$$10 \% < Cl < 26 \% ,$$
$$15 \% < Al < 30 \% .$$

2. The product according to claim 1, having the following chemical analysis, determined on the dry product by inductively coupled plasma spectroscopy, in % by weight
$$2 \% < Li < 5 \% ,$$
$$10 \% < Cl < 26 \% ,$$
$$15 \% < Al < 30 \% ,$$
elements other than Li, Cl, Al, O and H: <3%,
O and H: complement to 100%.

3. The product according to claim 1, wherein:
the water content is greater than 1% and less than 95%, and/or
an average size of lithiated bayerite crystallites of less than 23 nm.

4. The product according to claim 1, wherein:
a cumulative content of aluminum hydroxide and boehmite is less than or equal to 8%, and/or
the crystallized phases comprise lithiated bayerite, boehmite and/or an aluminum hydroxide chosen from gibbsite, bayerite, doyleite, nordstrandite and mixtures thereof.

5. The product according to claim 3 wherein:
the water content is greater than 5%, and/or
the water content is less than 80%, and/or
the crystallized phases comprise lithiated bayerite and an aluminum hydroxide selected from gibbsite, bayerite, doyleite, nordstrandite and mixtures thereof.

6. The product according to the preceding claim 5, wherein:
the water content is greater than 10%, and/or
the water content is less than 70%, and/or
the only crystallized phase is lithiated bayerite.

7. The product according to claim 1, consisting of at least 80% by weight of water and crystallites of lithiated bayerite, aluminum hydroxide and/or boehmite, and LiCl, and a binder.

8. The product according to claim 7, consisting of at least 80%, by weight, of water, and crystallites of lithiated bayerite, and aluminum hydroxide, and LiCl, and a binder.

9. The product according to claim 8, consisting of at least 80% by weight in total of water, lithiated bayerite crystallites, LiCl and a binder.

10. The product according to claim 7, wherein the binder is a polysaccharide.

11. The method of making a product according to claim 1 comprising:
a) providing an aqueous suspension of an aluminum source, selected from boehmite or aluminum hydroxide and mixtures thereof, grinding said aqueous suspension to a median size of 3 μm or less if the median size of the aluminum source is greater than 3 μm,
said suspension being maintained during this-step a) at a temperature of less than 50° C.;
b) increasing the pH by adding a base, such that a molar ratio between the OH supplied by said base and the Al present in the mixture is greater than 0.20, said mixture being kept stirring after introduction of said base, at a temperature below 50° C.;
c) of adding a chlorine salt, such that a molar ratio of Cl supplied by said chlorine salt to Al present in the mixture is greater than 0.25, said mixture being kept stirring after introduction of said chlorine salt at a temperature below 50° C.; the base in step b), the chlorine salt in step c) and their respective amounts being chosen so as to provide a quantity of lithium in the mixture such that the Li/Al molar ratio is greater than or equal to 1;
d) raising a temperature of the mixture to a temperature greater than or equal to 50° C. and less than or equal to 60° C., a time t₁ being the time during which said mixture is at a temperature greater than or equal to 50° C.;
e) maintaining the mixture at a temperature greater than or equal to 50° C. and less than or equal to 60° C. for a time t₂;
f) optionally, adding an acid to the mixture, with stirring, so as to reduce the pH of the mixture to 8 or less, the chlorine salt in step c), said acid and their respective quantities being chosen so that the Cl/Al molar ratio in the mixture is greater than or equal to 1, the mixture being maintained at a temperature less than or equal to 60° C., a time t₃ being the time during which the mixture is at a temperature greater than or equal to 50° C., the molar ratio between the Cl supplied by the chlorine salt and the Al present in the mixture being greater than or equal to 0.5 if the method does not include said step f);
g) optionally, filtration of the mixture so as to obtain a paste, the mixture being maintained at a temperature of less than or equal to 60° C., a time t₄ being the time during which the mixture is at a temperature of greater than or equal to 50° C.;
a cumulative time t₁+t₂+t₃+t₄=t₅ being greater than or equal to 45 minutes and less than 15 hours.

12. The method of making a product according to claim 11, wherein in step a) a grinding of the aqueous suspension of an aluminum source selected from a boehmite or aluminum hydroxide and mixtures thereof is carried out, so as to obtain a median size of ≤1 μm.

13. The method according to claim 11, wherein the time t₃ is such that the times t₁, t₂, t₃ and t₄ satisfy the following relationships: [t₁/(−1.2T₁+75)]+ [t₂/(−1.2T₂₀+75)]+ [t₃/(−1.2T₃₀+75)]+ [t₄/(−1.2T₄₀+75)]≤1 and [t₁/(−0.225T₁+14.25)]+ [t₂/(−0.225T₂₀+14.25)]+ [t₃/(−0.225T₃₀+14.25)]+ [t₄/(−0.225T₄₀+14.25)]≥1, where T₁ is the temperature reached by the mixture in step d), T₂₀ is the mean temperature in step e), T₃₀ is the mean temperature in step f), and T₄₀ is the mean temperature of the mixture during the time t₄.

14. The method according to claim 13, wherein the time t₅ is such that the times t₁, t₂, t₃ and t₄ satisfy the following relationships: [t₁/(−0.8T₁+50)]+ [t₂/(−0.8T₂₀+50)]+ [t₃/(−0.8T₃₀+50)]+ [t₄/(−0.8T₄₀+50)]≤1, and/or
the time t₅ is such that times t₁, t₂, t₃ and t₄ satisfy the following relationship: [t₁/(−0.2T₁+13)]+ [t₂/(−0.2T₂₀+13)]+ [t₃/(−0.2T₃₀+13)]+ [t₄/(−0.2T₄₀+13)]≥1.

15. The method according to claim 14, wherein time t₅ is such that times t₁, t₂, t₃ and t₄ satisfy the following relationship: [t₁/(−0.55T₁+34.5)]+ [t₂/(−0.55T₂₀+34.5)]+ [t₃/(−0.55T₃₀+34.5)]+ [t₄/(−0.55T₄₀+34.5)]≤1.

16. The method according to claim 11, wherein:
aluminum hydroxide, boehmite and mixtures thereof are the only sources of aluminum used in all the steps of said method, and/or
in step b), the molar ratio between the OH provided by the base and the Al present in the mixture is greater than 0.25 and less than 10, and/or
in step b), the pH of the mixture after addition of the base is greater than 9 and less than 13.

17. The method according to claim 11, wherein:
in step c), the molar ratio between the Cl supplied by the chlorine salt and the Al present in the mixture is less than 10, and/or
the base in step b), the chlorine salt in step c), and their respective amounts are chosen so as to provide an amount of lithium in the mixture such that the Li/Al molar ratio is greater than 1.1 and less than 4, and/or
in step d), the time t₁ is greater than 5 minutes.

18. The method according to claim 11, wherein:
in step e), the temperature of the mixture is substantially constant, and/or
in step e), the time t₂ is greater than 40 minutes, and/or
in optional step f) at least part of the amount of Cl necessary to obtain a Cl/Al molar ratio greater than 1 is provided by the acid.

19. The method according to claim 11, wherein:
in optional step f) the pH of the mixture is decreased to a value below 7.5 and above 6.5, and/or
in optional step f) the Cl/Al molar ratio in the mixture is set to a value less than 3, and/or
in optional step f) the temperature of the mixture is substantially constant.

20. The method according to claim 12 wherein:
in optional step f) the time t₃ is greater than 5 minutes, and/or
in step g), the time t₄ is less than 15 minutes.

21. The method according to claim 16, wherein aluminum hydroxide is the only source of aluminum used in all the steps of said method.

22. The method according to claim 11, wherein:
steps a) and b) are carried out simultaneously, and/or
steps a), b) and c) are carried out simultaneously.

23. The method according to claim 11, comprising, after step g), a step h) of shaping a starting material comprising the paste obtained at the end of step g), in the form of an object or a coating, and an optional step i) of reducing the water content of said object or said coating.

24. The method according to claim 23, wherein in step h) the starting filler comprises a binder.

25. The method according to claim 24, wherein the binder is a polysaccharide comprising a group capable of forming an ionic bond with a gelling agent for the formation of a gelled polysaccharide.

26. The method according to claim 25, wherein the polysaccharide is selected from alginates.

27. The method according to claim 23, wherein steps h) and i) are carried out at least partially simultaneously.

28. A device for collecting lithium, comprising a product according to claim 1.
